(19) United States
(12) Patent Application Publication
(10) Pub. No.: US 2026/0254839 A1
(43) Pub. Date: Aug. 27, 2026

(54) LOCAL AREA NETWORK EGRESS OPPORTUNITY PROBING APPLIANCE

(71) Applicant: Offensive Context LLC, Highlands Ranch, CO (US)

(72) Inventor: Evan Anderson, Highlands Ranch, CO (US)

(21) Appl. No.: 19/551,410

(22) Filed: Feb. 26, 2026

Related U.S. Application Data
(60) Provisional application No. 63/764,097, filed on Feb. 27, 2025.

(51) Int. Cl. H04L 9/40

(52) U.S. Cl. CPC H04L 63/1433; H04L 63/20; G06F 2221/034

(57) ABSTRACT

A system and method for identifying network security gaps by probing outbound egress opportunities from within a local area network. A probe agent, which may be implemented as a dedicated hardware appliance or software instance deployed behind a firewall, attempts outbound communications to a remote server across a range of virtual network port and protocol combinations and/or network interfaces. The remote server receives successful probe requests and evaluates the associated port and protocol combinations against applicable network security policies. Upon identifying a combination inconsistent with those policies, the remote server generates alerts and transmits notifications to designated recipients. The probe agent and remote server coordinate via DNS-based command and control, ensuring reliable communication even in highly restrictive network environments. Multiple probe agents may be deployed across distinct network segments to identify unauthorized inter-segment communication paths. Detected egress vectors are tracked over time to identify ephemeral or periodic firewall misconfigurations.

### CROSS-REFERENCE TO RELATED APPLICATION

This application is a nonprovisional of and claims the benefit under 35 U.S.C. § 119 of, U.S. Provisional Patent Application No. 63/764,097, filed on February 27, 2025, and entitled "Local Area Network Egress Opportunity Probing Appliance" the contents of which is incorporated herein by reference in its entirety.

### TECHNICAL FIELD

Embodiments described herein relate to computer and network security, and, in particular, to network security appliances that facilitate automatic identification of possible egress vectors through a local area firewall.

### BACKGROUND

A computing device associated to a local area network ("LAN") can be configured to communicate over one or more protocols with other devices and systems over a wide area network ("WAN"). A firewall of a LAN serves as a security checkpoint at the boundary between the LAN and a WAN, blocking network traffic that does not comply with all firewall rules.

In many cases, designing and deploying modern and secure firewall configurations requires specialized technical knowledge, as does ongoing monitoring of and operational validation of existing firewall rules. Further, a significant number of residential and commercial firewalls -- especially those incorporated in all-in-one modem devices distributed by internet service providers ("ISPs") -- are not readily, if at all, configurable by end users. These limitations have resulted in insecure firewall configurations remaining undetected for extended periods of time in both residential and commercial contexts. As a result, modern malicious software is increasingly exploitative of firewall misconfiguration detection delay.

### SUMMARY

A system as described herein can include a probe agent device connected to a network gateway of a local area network. The probe agent device includes a processor and memory configured to generate and transmit probe requests to a remote server, each probe request transmitted over a selected virtual network port using a selected networking protocol via a selected network interface device. The remote server receives or does not receive probe requests and, if a probe request is received, transmits notifications confirming receipt in response. A secure backend evaluates the port and protocol combination of each received probe request against one or more network security policies and generates an alert when a combination is found to be inconsistent with those policies.

A method as described herein includes selecting, by a probe agent, a virtual network port and networking protocol, and transmitting a probe request to a remote server over that port and protocol combination. The remote server receives the probe request, determines the associated port and protocol, and compares that combination against one or more network security policies. If the combination is found to be inconsistent with those policies, the remote server transmits a notification to a designated recipient.

A probe agent device as described herein can be configured to include one or more network interfaces configured to connect to a network gateway, and a processor and memory that cooperate to instantiate a software instance configured to generate and transmit probe requests to a remote server across a set of virtual network port and protocol combinations. A software- defined communication interface handles receipt of configuration instructions and transmission of probe results to the remote server. One or more illuminable indicators update in response to notifications from the remote server, communicating the compliance status of detected egress vectors with respect to applicable security policies.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified schematic representation of a system for automated identification of network egress opportunities, such as described herein.

FIG. 2 depicts another schematic representation of a system, such as described herein.

FIG. 3 depicts another schematic representation of a system, such as described herein.

FIG. 4 depicts another schematic representation of a system, such as described herein.

FIG. 5 depicts an example network security appliance, such as described herein.

FIG. 6A depicts an example user interface displaying an alert, such as described herein.

FIG. 6B depicts an example graphical user interface, such as described herein.

FIG. 7 is a flowchart depicting example operations of a method of automated identification of vulnerabilities, such as described herein.

FIG. 8 is a flowchart depicting example operations of a method of automated identification of vulnerabilities, such as described herein.

FIG. 9 is a simplified flowchart depicting example operations of a method of automated identification of vulnerabilities, such as described herein.

FIG. 10 is another simplified flowchart depicting example operations of a method of automated identification of network vulnerabilities, such as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for automatically identifying misconfigurations of firewall rules enforced within a local area network ("LAN"). Further, embodiments described herein relate to methods for alerting users and/or network administrators of potential misconfigurations of firewall rules, so that, for example, action may be taken to improve security of a given LAN, a ticket may be opened in an information technology support system, a network may be automatically disabled until maintenance/validation can be performed, and/or firewall rules can be automatically updated, and the like.

As may be known to a person of skill in the art, application layer requests originating within a LAN, such as a Hypertext Transfer Protocol ("HTTP") request from a browser, are typically encapsulated within Transmission Control Protocol ("TCP") segments (or other segments or chunks corresponding to other transport layer protocols), which are further encapsulated in internet protocol ("IP") packets, which in turn are wrapped in ethernet packets, for transmission over the physical layer between network devices within the LAN. These packets may, in many cases, be addressed in a manner requiring egress from the LAN, traversing a network boundary between the LAN and a Wide Area Network ("WAN") to a remote IP address. Such packets can be referred to herein as "outbound packets" or, more generally, as "outbound network traffic."

Each outbound packet must traverse the LAN's firewall, which may be configured to inspect the packet headers, payload, and/or transport-layer metadata before determining whether to pass, drop, or actively block the packet. In some instances, firewalls may employ deep packet inspection to analyze the contents of network traffic beyond header or metadata information. Broadly, firewall policies - in part - are intended to define acceptable/approved source and destination ports, permitted protocols, and other rules governing outbound network traffic. These rules are intended to ensure that information originating from within (or accessible only within) a LAN is only permitted to exit the LAN in controlled and known circumstances.

As such, as noted above, an incorrectly-configured firewall can expose a potential egress vector that a network owner or network user does not expect. For example, a firewall rule may be disabled for network testing but not reenabled after testing completes. In other cases, a particular port may be opened by a user for a specific limited purpose (e.g., self-hosting a website or gaming server) without that user appreciating the collateral security risks associated with opting to open such ports. In some examples, one user of a shared network may open a port for a personal purpose, without the knowledge or consent of other users of the same network.

More broadly, some LANs have misconfigured or insecurely-configured firewalls. These include residential internet service customers and business internet customers alike. Such LANs can serve as tempting targets for malicious actors and represent a significant information security liability.

Problematically, firewall misconfigurations are often only noticed once data theft has occurred. In other cases, a firewall misconfiguration can be identified by performing periodic security audits, but many residential and business internet service customers do not perform and/or cannot afford such audits. Even still, a firewall may be reconfigured/misconfigured between audits. In certain circumstances, malicious actors can gain control of firewall configurations and may only temporarily adjust firewall configuration to evade detection; such ephemeral actions may not be detectable at all even with the most rigorous and thorough security audits.

Further to the foregoing, many internet service provider ("ISP")-issued on-premises devices explicitly do not permit end users to adjust firewall configurations. In such examples, the existence of a misconfigured firewall may be entirely opaque to end users.

To address these security gaps and information gaps, embodiments described herein relate generally to systems configured to conduct outbound network traffic testing to evaluate firewall configuration(s) of a particular LAN, independent of a user's ability to access, modify, or control that firewall. The system can include a probing agent (a hardware device or a software instance) disposed behind a firewall and configured to attempt outbound communication with a remote server over a variety of port and protocol combinations.

On successful communication between a probing agent and the remote server, the system can analyze or otherwise evaluate whether such communications should have been blocked by firewall rules in view of industry-standard, site-specific, or otherwise advisable security standards. In this manner, the system can enumerate, for a specific LAN, port and protocol combinations that could be used for outbound communications to, for example, facilitate undetected data egress by malicious software or hardware.

A probing agent as described herein can be configured to iterate through virtual network ports sequentially or may prioritize particular ports and protocol combinations based on predefined or dynamically determined (e.g., LAN context specific) criteria. For example, a probing agent as described herein may attempt outbound communications over different protocols such as TCP, UDP, or SSH over non-standard ports to determine which outbound communication paths permit successful transmission to the remote server.

A probing agent and the remote server can be configured to communicate and/or exchange information via DNS tunneling, also referred to as DNS-based command-and-control ("DNS C2"). This technique can ensure that even with an appropriately configured firewall, a probing agent and a remote server can effectively coordinate to perform probing operations across nonstandard or nonessential open ports of the LAN.

For example, a unique identifier can be transmitted from a probing agent to a remote server via DNS C2 communication. This unique identifier can be used by the remote server to associate an IP address with a particular probing agent. Thereafter, connection requests received from this IP address can be attributed to the LAN associated with the identified probing agent. In other cases, DNS C2 can be leveraged by the probing agent to report closed port and protocol combinations back to the remote server.

In this manner, a probing agent can be configured to identify itself to the remote server (e.g., via DNS C2), to select one or more ports and protocols with which to attempt communications to the remote server (or other endpoints, which may be cloud-based virtual computing devices associated with different geographies or infrastructure/hosting providers), to attempt communications via a particular port and protocol combination, wait a timeout period for the remote server to return a response (which may be via a direct response or may be provided in response to subsequent DNS requests from the agent), and determine whether the port and protocol combination is a permitted egress path from the LAN to the WAN. Thereafter, the agent may wait for a random delay to throttle its outbound requests and select another port and protocol combination with which to probe the firewall's configuration. In this manner, cooperation of the remote server and the agent assemble and/or otherwise enumerate combinations of ports and protocols that permit outbound traffic.

The set of available outbound ports and protocol pairs can thereafter be analyzed by either the remote server or the agent to determine whether those pairs represent unnecessary risk for the particular LAN. For example, the port and protocol pairs can be compared to a policy document or set of business rules to determine whether the associated firewall can be configured in a more appropriate or secure manner. Upon making such a determination, the remote server may cause to be transmitted a notification to a network administrator, a network user, an ISP, or another recipient to notice that recipient of a suboptimal network configuration at the subject LAN. In other cases, the remote server can instruct the probe agent to illuminate a light, update a display, or otherwise provide an audible, visible, or tactile alert on premises to notify users of the LAN that security may be improved.

More generally, embodiments described herein relate to devices and/or software instances configured to be installed or instantiated within a LAN (e.g., behind a firewall). These devices are configured to periodically attempt to signal one or more remote servers via one or more virtual network ports over one of a set of communications protocols. Because such traffic originates from within the LAN, it only has the potential to reach the remote server if that traffic complies with all firewall rules enforced by the firewall of that LAN, the internet service provider ("ISP") serving the site, and any other intervening firewalls. In these embodiments, the remote server can be configured to store, in a database, information in respect of each successful connection, including among other information a timestamp, a protocol, and a transport layer virtual network port through which the connection was established. Thereafter, the remote server can be configured to validate each connection against one or more network security policies or standards.

More specifically, the remote server may be configured to determine, for a particular successful connection, whether that given combination of virtual network port and protocol should - according to one or more security policies - have been blocked by the LAN's firewall. Upon determining that a particular successful connection should not have been permitted, the remote server can perform an action, such as creating a reporting, signaling the firewall to reconfigure, signaling an ISP firewall to provide supplemental protection of particular ports and/or protocols, causing an alert to be transmitted to an administrator associated with that particular LAN, or any other suitable action. In some cases, the remote server can be configured to signal the probing agent device and/or software instance resident within the LAN to illuminate or flash a status light, to provide haptic feedback, to emit a sound, or to provide any other suitable physical, visual, acoustic, or other notification to persons nearby that device.

Broadly, processes of cooperation between local devices (and/or software instances) and remote servers or services as describe herein may be referred to herein as "egress opportunity probing" operations. Similarly, a LAN-connected device configured for egress opportunity probing may be referred to as a "probe" or a "probe agent." In some cases, an instance of software instantiated by cooperation of a processor and memory of a computing appliance connected to a LAN can be configured to operate as a probe agent. In other cases, a probe agent may operate on dedicated hardware, including a processor, memory, and at least one network interface (e.g., ethernet, Wi-Fi, optical, or the like).

As described herein, a probe agent may be installed into/disposed within a local network behind a firewall. The firewall may be a dedicated appliance or may be a function or service of another device, such as a network gateway, an all-in-one modem, or the like. The probe agent may be configured to probe for egress opportunities, such as open outbound ports as mentioned, through which sensitive information may be exfiltrated from the local network.

As described herein, egress opportunity probing can be performed in whole or in part using a probe agent. For example, the probe agent may be configured to formulate and transmit outbound traffic over various protocols through different ports of a network gateway. Accordingly, outbound requests (e.g., traffic) may be configured to a target a particular destination beyond the firewall, such that upon receiving the outbound request at the particular destination, a notification or alert may be generated indicating that the outbound request was received over the open internet. Outbound requests used to probe for egress opportunities may be referred to herein as probe requests. The destinations that probe requests may be targeted toward may be referred to herein as remote servers.

A remote server as described herein may be associated with one or more hosts, domains, or infrastructure providers. It will be appreciated that a probe agent may be associated with multiple remote servers, and conversely, a remote server may be associated with multiple probe agents. Egress opportunity probing may include operations such as formulating and attempting to transmit probe requests to one or more remote servers, and as mentioned, probe requests may be attempted through multiple ports over multiple networking protocols.

For example, broadly, embodiments described herein build upon and supplement upon industry standard cybersecurity and firewall penetration (outbound) testing solutions by introducing a dedicated probing agent which may be implemented in software or hardware that is designed to automatically evaluate outbound network security risks with minimal configuration or user intervention. As a result, the probing agent can, itself, be manufactured in a substantially static manner (e.g., with static encryption keys, immutable program logic, and so on) so as to prevent any malicious use thereof. In particular, although existing network configuration testing tools may be used for network scanning (e.g., inbound open ports), such tools often require advanced technical knowledge, manual execution, or explicit user permissions to perform assessments; even still, such assessments focus on inbound traffic. In addition, many firewall assessment techniques rely on passive traffic analysis rather than proactive egress opportunity validation which may lead to false assurance that ports are actually blocked. As a trivial example, a firewall itself may be compromised and may indicate via user interfaces or administrative interfaces that certain ports are blocked. In other cases, network appliances may be improperly installed. As an example, a network switch may interpose a modem and a firewall, rendering the firewall entirely powerless to evaluate or block traffic coupled to that switch. In other cases, firewall software may contain software bugs that result in certain ports being reported as blocked when traffic is able to leverage those ports to communicate externally. More simply, many circumstances exist in which relying on passive network scanning and/or unaudited trust of firewall functionality, configuration, and installation is not advisable.

Embodiments described herein address these limitations by providing an autonomous and simple to install and operate system configured to iteratively test outbound communication paths across various network ports and protocols, analyze firewall enforcement policies, and alert users to potential misconfigurations in a manner that is accessible to both technical and non- technical users alike. Such devices can communicate over multiple ports, multiple network interfaces, wireless network interfaces, wired network interfaces, or combinations thereof. By leveraging a remote validation architecture in which a site-installed device requires only coupling to an available network port or wireless network, security assessments can be reliably and continually performed (e.g., to detect changes in firewall rules over time, or time-specific firewall rules) even in environments where firewall configurations are not accessible to end users, such as ISP-managed residential or commercial gateways.

More broadly, many embodiments relate to methods and systems for dynamically selecting and evaluating network egress opportunities by leveraging a probe agent configured to systematically test a range of ports and protocols. A probe agent may prioritize specific ports and protocols based on predefined security policies, historical threat intelligence, or real-time contextual analysis of network traffic patterns. For example, the probe agent may reference a dynamically maintained risk database (maintained by a remote server as described herein) that associates specific port and protocol combinations with known malware behaviors or common data exfiltration techniques. Port/protocol selection logic may be further refined using heuristic methods or trained neural networks or generative output systems, wherein ports historically associated with misconfiguration errors-such as those commonly used for personal game servers, peer-to-peer applications, or legacy services-are tested with increased frequency. Additionally, embodiments described herein may incorporate a dynamic throttling mechanism to regulate probe request frequency, reducing unnecessary network load while ensuring a comprehensive assessment of firewall enforcement.

As noted above, in some embodiments, a probe agent and associated remote validation services may leverage Domain Name System (DNS) tunneling or similar techniques to facilitate indirect communication in environments where direct outbound connections are restricted. It is appreciated that while DNS-based communication methods are commonly associated with malicious activity, embodiments described herein implement strict cryptographic authentication and validation mechanisms to ensure reliable, secure, and privacy respective communications of only essential information. Specifically, unique cryptographic keys may be assigned to each probe agent, with all outbound DNS-based communications cryptographically signed and verifiable against a remote trust authority, which may be integrated into or separate from the remote validation service as described above. Further, certain embodiments described herein may incorporate policy-based controls to disable or restrict specific communication methods based on enterprise security policies, compliance frameworks, or regional data protection regulations. By implementing these security controls, embodiments ensure that probing operations are conducted in a controlled, auditable, and policy-compliant manner.

In certain embodiments, DNS C2 may not be required unless a probe agent determines that other methods for communicating with remote services fails. For example, a probe agent as described herein can be configured to attempt communications via TCP first. Upon determining that a firewall blocks such traffic, a probe agent may shift to VPN or other tunneling techniques. In response to determining that a VPN connection cannot be established, the probe agent can default to DNS C2 communications. In some circumstances in which DNS communications are also blocked, a probe agent may include a failover modem (e.g., cellular modem) to communicate with remote services in a different manner. In other cases, a probe agent can be configured to attempt connection to nearby open wireless networks. Many configurations and options are possible to facilitate communications between a probe agent as described herein and a remote validation service to perform egress opportunity scanning operations as described herein.

In some embodiments, upon successful egress detection, a system as described herein may generate structured alerts that provide actionable insights to network users, administrators, or security operations teams. Alerts may be categorized based on risk severity, wherein high-risk egress vectors-such as unauthorized use of administrative protocols (e.g., SSH, RDP, or the like) or anomalous outbound traffic to geolocated threat domains-are prioritized for immediate attention and mitigation. In addition to notifying relevant product/service owners, some embodiments described herein may automatically cause remediation action, such as dynamically updating firewall rules (e.g., via accessing firewall configuration pages and/or manipulating firewall user interfaces to adjust firewall configurations), integrating with security information and event management platforms, or issuing automated support tickets via enterprise IT management systems. In some instances, network quarantine measures (e.g., disabling network connections, disabling network appliances, routing all traffic to a remote firewall, and so on) may be applied until a detected security risk is resolved, ensuring that identified vulnerabilities are addressed in a timely manner.

Further to the foregoing, probe agent embodiments as described herein may be deployed in a variety of network environments, including residential, commercial, and enterprise-scale LANs. In some instances, a probe agent may be instantiated as a dedicated hardware appliance incorporating an embedded processor, memory, and network interface. Such examples can include a display, an indicator light, a speaker, a vibration element or other haptic element, or any other suitable hardware.

In some embodiments, false positive reduction techniques may be implemented to ensure that detected egress opportunities represent genuine security risks rather than intended firewall configurations. For example, a probe agent may leverage contextual analysis by cross- referencing detected open ports, other network devices, listed or detected services, site type, configuration type, and so on against network policy definitions, user-defined exception lists, or dynamic risk scores assigned to specific communication patterns (e.g., combinations of particular ports, particular protocols and particular associated NetFlow information). Additionally, a probe agent may incorporate adaptive learning mechanisms that adjust probing strategies based on historical results, thereby reducing redundant alerts for known, approved configurations while maintaining sensitivity to newly emerging risks. By implementing such validation techniques, embodiments described herein ensure that security alerts remain both actionable and relevant to users and administrators.

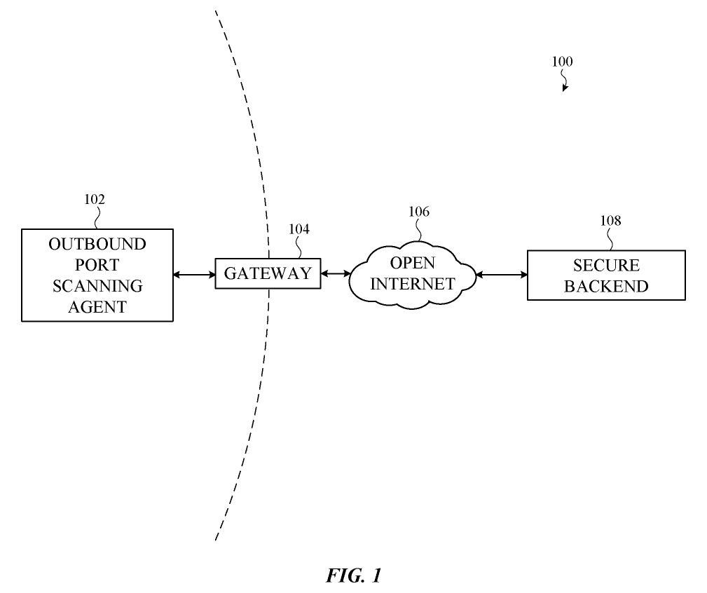

These foregoing and other embodiments are discussed below with reference to FIGS. 1-10. However, those skilled in the art will readily appreciate that the detailed description given herein with respect to these figures is for explanation only and should not be construed as limiting.

In particular, FIG. 1 depicts a simplified schematic representation of a probe agent 102 inserted behind a firewall 104. The probe agent 102 can be configured to communicate with the gateway 106. As mentioned, a gateway such as the gateway 106 may provide virtual network ports through which communications from behind the firewall 104 may pass into the open internet 108.

The probe agent 102 may be configured to attempt to transmit probe requests through the gateway 106. That is, if the firewall 104 is not configured to prevent a particular probe request from passing through the gateway 106, the probe request may reach the open internet 108.

As described herein, probe requests may be directed to a remote server, such as the secure backend 110. The secure backend 110 may be configured to respond to a received probe request by returning a notification, alert, message, or other response. For instance, upon a probe request reaching its remote server (e.g., the secure backend 110), the secure backend may be configured to transmit notifications to a user account or client device associated with the probe agent 102, or in many cases, the secure backend 110 may be configured to transmit a response to a received probe request to the probe agent 102 itself.

The network gateway (e.g., the gateway 106) may be configurable to support traffic through any virtual network port. As such, the probe agent 102 may in some examples be configured to prioritize particular ports and protocols (and combinations thereof) when probing for egress opportunities. For instance, a particular port may be commonly opened by users to host particular services (e.g., port 25565 may be opened to both inbound and outbound TCP/UDP traffic in order to host private game servers, whereas ports 80, 8080, and 443 may be opened to host private websites or web services). For example, known malware or malicious hardware may prefer particular port ranges and protocols; these port ranges and protocols may be accordingly prioritized by the probe agent 102.

The firewall 104 may be configured to only allow traffic of a certain type to pass through a particular virtual network port (e.g., only traffic using certain protocols or going in a certain direction through the firewall). For example, a port may only be opened for outbound traffic conforming to the SSL protocol over TCP.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

In a simplified operational example, the outbound port scanning agent 102 may be configured for selecting a virtual network port and protocol combination and thereafter transmitting a probe request addressed to the secure backend 108. The probe request may traverse the gateway 104 and, if not blocked by the firewall boundary represented by the dashed line in FIG. 1, may reach the secure backend 108 via the open internet 106. Upon receiving the probe request, the secure backend 108 may be configured for transmitting a return notification to the outbound port scanning agent 102, confirming that the selected port and protocol combination represents an available egress vector from the LAN.

As depicted in FIG. 1, and as noted above, the dashed line represents a firewall boundary separating the LAN-side network environment from the open internet 106. The outbound port scanning agent 102 is intentionally disposed on the interior side of the firewall boundary, such that probe requests generated by the outbound port scanning agent 102 are subject to all firewall rules enforced at the gateway 104. In some embodiments, the firewall boundary may be enforced by a dedicated firewall appliance distinct from the gateway 104. In other embodiments, the firewall boundary may be enforced by firewall functionality integrated directly into the gateway 104, such as in configurations where the gateway 104 is an ISP-issued all-in-one device incorporating modem, router, and firewall functionality within a single appliance.

For embodiments in which the gateway 104 is an ISP-issued all-in-one device, the firewall configuration of the gateway 104 may not be accessible or modifiable by the end user. In such configurations, the outbound port scanning agent 102 may nonetheless be configured for detecting and reporting egress opportunities present in the gateway 104, independent of any end- user access to firewall settings. As a result, firewall misconfigurations that would otherwise remain entirely opaque to the end user may be identified and reported.

In some embodiments, the secure backend may be instantiated across multiple geographic regions or infrastructure providers. In such configurations, the outbound port scanning agent may be configured for directing probe requests to different backend endpoints across different probing cycles, such that the availability of at least one backend endpoint may be confirmed across a range of network conditions. Probe requests directed to different endpoints may also serve to detect egress filtering policies that are destination-specific, such as firewall rules configured to block outbound traffic addressed to particular IP address ranges or autonomous system numbers.

The outbound port scanning agent may be configured as a low-power, minimal- footprint appliance requiring only a connection to an available network port of the gateway to begin probing operations. In some embodiments, the outbound port scanning agent may be pre- provisioned prior to deployment with all configuration information necessary to identify itself to the secure backend and to begin transmitting probe requests, such that no additional setup steps are required of the end user upon installation.

Prior to initiating port-and-protocol probing operations, the outbound port scanning agent may be configured for establishing an initial communication channel with the secure backend via DNS-based command and control. DNS-based communication may be leveraged for the initial handshake because DNS traffic is unlikely to be blocked at the gateway in residential, commercial, or industrial network environments. Upon completing the initial handshake, the secure backend may be configured for transmitting configuration information to the outbound port scanning agent, which may include a probing schedule, a prioritized list of ports and protocols, and any applicable network security policies against which detected egress vectors may be evaluated.

In some embodiments, the outbound port scanning agent may be configured for periodically releasing and renewing a DHCP lease, such that the outbound port scanning agent may be assigned a different internal IP address within the LAN across different probing cycles. In configurations where firewall rules or network access policies are applied on a per-IP-address basis, varying the internal IP address of the outbound port scanning agent across probing cycles may reveal differences in the egress opportunities available to different IP address blocks within the LAN.

Further, the outbound port scanning agent may be configured for programmatically modifying the MAC address presented by a network interface controller prior to requesting a new DHCP lease. In some embodiments, the MAC address may be selected from a set of MAC addresses attributed to particular hardware manufacturers or device classes, such that the outbound port scanning agent may present itself to the gateway as a device of a particular type. For example, a MAC address associated with a known mobile device manufacturer, a network- attached storage device, or an industrial control system may be selected, such that any MAC address-based access policies enforced by the gateway may be exercised and evaluated across different probing cycles.

In some embodiments, the outbound port scanning agent may be configured for temporarily disconnecting from the network and reconnecting with a modified MAC address, such that a fresh DHCP lease and a different internal IP address may be obtained. By repeating the probing sequence following each such reconnection, the outbound port scanning agent may be configured for assembling a comparative record of egress opportunities observed across different IP addresses and MAC address identities within the same LAN. Differences in observed egress vectors across these varying network identities may be indicative of per-device or per- address-range access policies enforced at the gateway, which may themselves represent security gaps warranting further investigation and remediation.

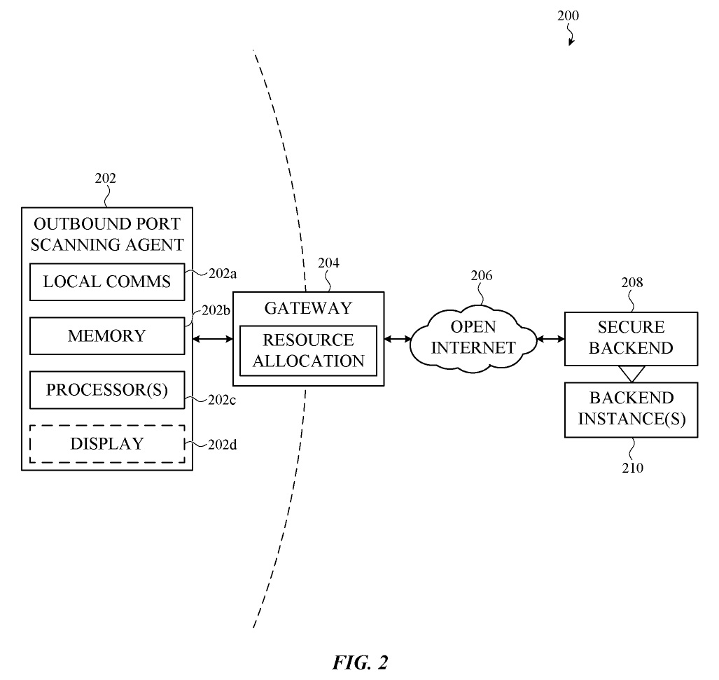

FIG. 2 depicts a configuration in which the probe agent 202 is a device disposed within a LAN protected by a firewall 204. For example, the probe agent 202 may include operational features, such as a processor, a memory, a display, and/or a local communications or networking interface (see, e.g., elements 202a-d). For example, local communications may the probe agent 202 to communicably couple to, for instance, the gateway 206. The local communications component 202a may be a virtual (e.g., application programming interface) or physical communication interface (e.g., ethernet, Wi-Fi, Bluetooth, USB, and so on).

As described herein, the term "processor" refers to any software and/or hardware- implemented data processing device or circuit physically and/or structurally configured to instantiate one or more classes or objects that are purpose-configured to perform specific transformations of data including operations represented as code and/or instructions included in a program that can be stored within, and accessed from, a memory, such as the memory 202b. This term is meant to encompass a single processing unit or processor, multiple processors, multiple processing units, analog or digital circuits, or other suitably configured computing element or combination of elements.

The probe agent 202 may also include a display 202d. The display 202d may be configured to provide information or indications to a user of the agent. For instance, display 202d may include an LED indicator that illuminates in response to the probe agent 202 receiving a response from the secure backend 210 indicating that an egress probe has been received by the secure backend 210 (e.g., that a vulnerability exists). The display 202d may further include, for example, a text display that may describe the particular port and/or protocol over which the probe request successfully egressed the network.

These foregoing embodiments depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in some embodiments, the local comms component of an outbound port scanning agent may be configured to support one or more wired and/or wireless network interfaces, each of which may independently participate in probing operations. In some embodiments, each available network interface may be configured for transmitting probe requests across the same set of port and protocol combinations, such that any differences in egress opportunities observable across different network interfaces may be detected and recorded. For example, a wired ethernet interface and a wireless interface present on the same outbound port scanning agent may be subject to different firewall rules enforced at the gateway, and probing across both interfaces may reveal such asymmetries.

A memory of the outbound port scanning agent may be configured for storing a variety of pre-provisioned and dynamically updated information necessary for probing operations that may client specific and/or site-specific. In some embodiments, the memory may store configuration data provisioned prior to deployment, including cryptographic keys for authenticating communications with the secure backend, a prioritized list of port and protocol combinations to be probed, and scheduling information defining the frequency and timing of probing cycles. Additionally, the memory may be configured for storing locally cached probe results, such that a history of observed egress vectors may be maintained on the outbound port scanning agent and compared against results obtained in subsequent probing cycles to detect changes in firewall configuration over time.

In some embodiments, the memory may further store one or more network security policy definitions against which detected egress vectors may be evaluated locally, without requiring a round-trip communication to the secure backend. For example, a policy definition stored in memory may identify particular port and protocol combinations such as high-risk, such that the outbound port scanning agent may be configured for generating a local alert upon detecting that a probe request transmitted over a high-risk combination was successfully received by the secure backend.

The processor or processors of the outbound port scanning agent may be configured as a system-on-chip or other embedded processing architecture, such that the outbound port scanning agent may be manufactured as a minimal, purpose-configured appliance having only the computational resources necessary to support probing operations. In some embodiments, the processor may be configured for executing a statically compiled probing agent software instance, such that the program logic of the outbound port scanning agent may be substantially immutable following manufacture. In such configurations, the risk of the outbound port scanning agent being leveraged for purposes other than those for which the outbound port scanning agent was designed may be substantially reduced.

As depicted in FIG. 2, the display is represented as an optional component, indicated by the dashed box treatment in the figure. In some embodiments, the display may be a simple LED indicator or set of LED indicators configured for communicating the current operational status of the outbound port scanning agent to a nearby user. In other embodiments, the display may be a small text or graphical display configured for presenting more detailed information, such as the most recently detected egress vector, the current probing schedule, or a summary of policy compliance status. In configurations where no display is present, status information may instead be communicated to a user via notifications transmitted by the secure backend to a designated client device.

For embodiments in which the display is present, the display may be configured for updating in response to notifications received from the secure backend following successful probe requests. For example, the display may be configured for presenting a visual indicator distinguishing between egress vectors that are consistent with applicable security policies and those that represent potential misconfigurations. In some embodiments, the display may be further configured for presenting actionable information, such as the specific port and protocol combination associated with a detected misconfiguration, such that a network administrator or end user in proximity to the outbound port scanning agent may be promptly informed without requiring access to a separate client device or administrative interface.

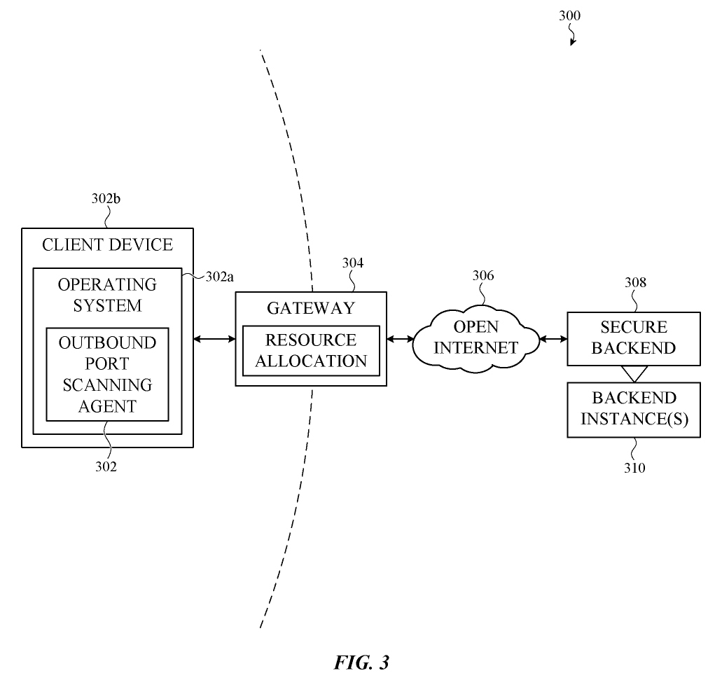

FIG. 3 depicts a configuration where the probe agent 302 is embedded within the operating system 302a of a client device 302b. For example, the probe agent 302 may be a virtual software component running within the operating system 302a. In these and like configurations, the probe agent may use the processors, memory, networking components, and local communications components of the client device 302b to formulate and transmit probe requests.

As mentioned, the secure backend 310 (and, by extension, the backend instances 312) may be configured to respond to a received probe request by generating and transmitting notifications, alerts, or the like, as described in greater detail herein. For instance, the client device 302b may be configured to render an alert in response to a notification received from the secure backend 310 (e.g., through a display communicably coupled to the operating system 302a), thus notifying a user associated with the probe agent 302 that a vulnerability (e.g., an open port providing an egress opportunity) has been detected.

In the configuration depicted in FIG. 3, the outbound port scanning agent may be instantiated as a software instance executing within the operating system of a general-purpose client device, such as a laptop computer, desktop computer, or other networked computing device. In such configurations, the outbound port scanning agent may be configured for leveraging the processor, memory, and network interfaces of the host client device to formulate and transmit probe requests, without requiring dedicated hardware. In some embodiments, the outbound port scanning agent may be packaged as a background service or daemon configured for executing continuously within the operating system, such that probing operations may be performed without requiring active user interaction with the client device.

In some embodiments, the outbound port scanning agent may be integrated at the operating system level as a system service or kernel-adjacent process, such that the outbound port scanning agent may have direct access to one or more network interfaces of the client device. In such configurations, the outbound port scanning agent may be configured for transmitting probe requests via each available network interface of the client device independently, such that any differences in egress opportunities observable across different network interfaces may be detected and recorded. For example, a client device having both a wired ethernet interface and a wireless network interface may be configured for probing outbound egress opportunities via each interface in succession, such that interface-specific firewall policies enforced at the gateway may be identified.

As described with respect to preceding embodiments, the client device may serve a dual role as both the source of outbound probe requests and the recipient of notifications transmitted by the secure backend in response to successfully received probe requests. In such configurations, the outbound port scanning agent may be configured for receiving notifications from the secure backend and causing alerts to be rendered directly on the display of the client device, such that a user of the client device may be promptly informed of detected egress opportunities without requiring access to a separate administrative interface or device.

In some embodiments, the outbound port scanning agent software may be installed on multiple client devices connected to the same LAN, such that probing operations may be performed concurrently from different internal IP addresses and device types. In such configurations, the secure backend may be configured for aggregating probe results received from each client device and assembling a comprehensive map of egress opportunities observable from different positions within the LAN. Differences in observed egress vectors across different client devices may be indicative of per-device or per-subnet access policies enforced at the gateway, which may themselves represent security gaps warranting further investigation.

For example, an organization may deploy the outbound port scanning agent software across a set of employee workstations, each of which may be assigned to a different network segment or VLAN within the organizational LAN. In such a configuration, probing operations performed concurrently across multiple client devices may reveal asymmetries in firewall rule enforcement across different network segments, such as a particular VLAN exhibiting more permissive outbound port access than would be consistent with security policies. The secure backend may be configured for correlating observations across all deployed instances of the outbound port scanning agent and generating a consolidated report of detected egress opportunities organized by network segment, device type, and observed port and protocol combination.

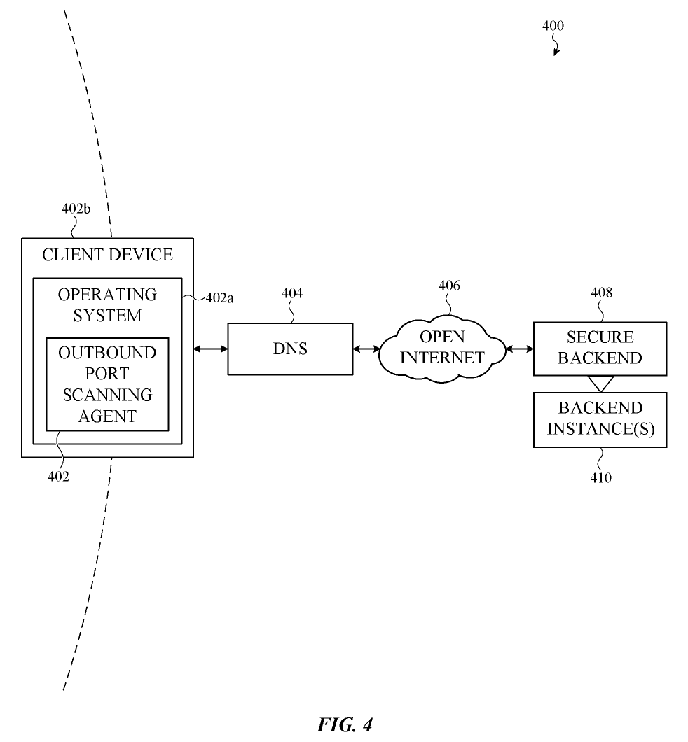

FIG. 4 depicts a configuration where the probe agent 402 is embedded within an operating system 402a of a local network gateway 402b. For example, a probe agent as described herein may be directly integrated with a router, modem, Wi-Fi node, all-in-one networking device, and the like (e.g., gateway 406).

In the configuration depicted in FIG. 4, the outbound port scanning agent may be configured for communicating with the secure backend primarily via DNS-based command and control, such that all coordination between the outbound port scanning agent and the secure backend - including probe scheduling, configuration updates, and reporting of observed egress vectors - may be conducted via DNS query and response pairs. In such configurations, the outbound port scanning agent may be configured for encoding probe result information within DNS queries addressed to a domain controlled by the secure backend, such that the secure backend may be configured for extracting and recording probe result information from received DNS queries without requiring a direct TCP or UDP connection between the outbound port scanning agent and the secure backend.

As with other embodiments described herein, DNS-based communication may be leveraged as a primary communication channel in network environments where direct outbound connections to the secure backend may be restricted or unpredictable. DNS traffic is broadly permitted across residential, commercial, and industrial network environments, as DNS resolution is a foundational requirement of general internet connectivity. As a result, the outbound port scanning agent may be configured for reliably exchanging information with the secure backend via DNS-based communication even in network environments exhibiting highly restrictive outbound firewall policies, where many or most non-DNS egress vectors may be blocked at the gateway.

In some embodiments, the secure backend may be configured for transmitting configuration instructions and probing schedules to the outbound port scanning agent via DNS response records, such as TXT records or other suitable DNS record types configured for carrying key-value data. Upon receiving a DNS response from the secure backend, the outbound port scanning agent may be configured for parsing the response to extract any configuration updates or instructions encoded therein, and for updating locally stored configuration data accordingly. In such configurations, the secure backend may be configured for dynamically adjusting the probing behavior of one or more deployed outbound port scanning agents without requiring any direct interaction with the client device on which the outbound port scanning agent is executing.

In some embodiments, the DNS communication path itself may be treated as an egress vector subject to evaluation alongside other port and protocol combinations probed by the outbound port scanning agent. For example, the outbound port scanning agent may be configured for probing whether DNS traffic addressed to different external resolvers or name servers is permitted by the network environment, such that the scope and nature of permitted DNS egress may be recorded and evaluated against applicable security policies. In configurations where DNS traffic is permitted to reach arbitrary external resolvers rather than only a designated internal or ISP-provided resolver, the secure backend may be configured for generating a notification identifying such a configuration as a potential security gap, as unrestricted DNS egress may represent an avenue for data exfiltration via DNS tunneling by malicious software or hardware operating within the LAN.

Further, the outbound port scanning agent may be configured for detecting whether DNS traffic is subject to inspection, filtering, or redirection by the network environment. For example, certain network configurations may redirect all outbound DNS queries to an internal resolver regardless of the destination address specified in the query, such that DNS-based communication with the secure backend may be intercepted or disrupted. In such configurations, the outbound port scanning agent may be configured for detecting the presence of DNS redirection by comparing the responses received from different queried resolvers, and for reporting such observations to the secure backend as additional context relevant to the overall security posture of the network environment.

All DNS-based communications between the outbound port scanning agent and the secure backend may be cryptographically signed and authenticated, such that the integrity and origin of all exchanged information may be verified by both parties. In some embodiments, each outbound port scanning agent may be provisioned prior to deployment with a unique cryptographic key, which may be leveraged to sign all outbound DNS queries transmitted by the outbound port scanning agent. The secure backend may be configured for verifying the cryptographic signature of each received DNS query against a registry of provisioned keys, such that DNS queries received from unrecognized or unauthenticated sources may be discarded without being processed or recorded.

These foregoing embodiments depicted in FIGS. 1-4 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

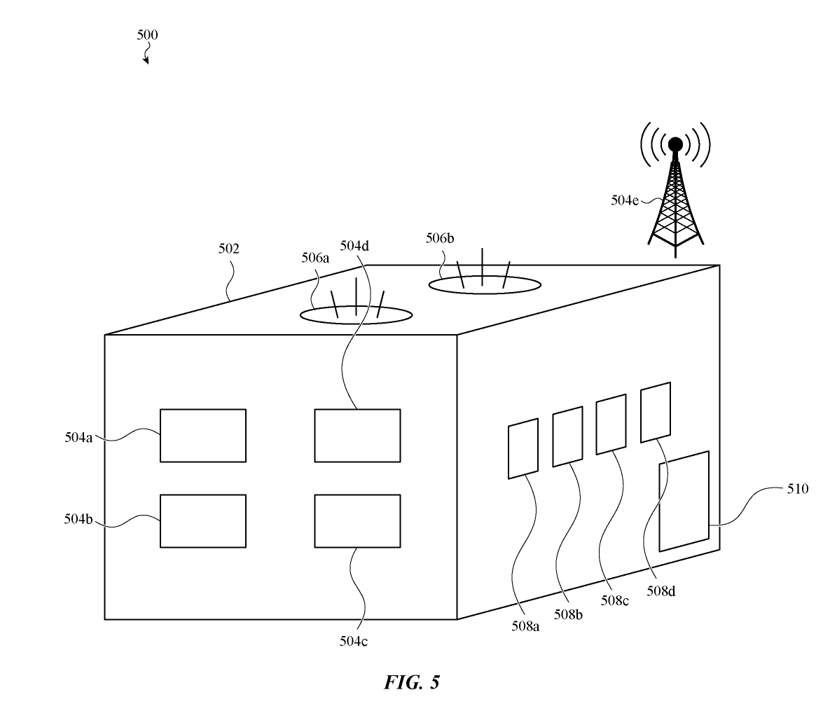

FIG. 5 depicts an example probe agent device 502, such as one that might be used with respect to FIG. 2. As depicted, the probe agent device 502 may include physical network ports 504a-d, such as ethernet port 504a, for directly connecting to networked devices (e.g., a network gateway). Similarly, the probe agent device 502 may include wireless connection means 504e, such as for Wi-Fi, Bluetooth, radio, and the like.

The probe agent device 502 may include illuminable indicators 506a-b, which may illuminate, change color, blink, or otherwise responsively update as egress opportunity probing is conducted. For example, illuminable indicator 506a may be a red LED configured to blink as egress opportunity probing is conducted and illuminate solidly when probing has concluded and a vulnerability has been detected. Similarly, 506b may be a green LED configured to illuminate solidly when no unaddressed vulnerabilities have been detected, or to blink green when egress opportunity probing is being conducted but no vulnerability has yet been detected.

The probe agent device 502 may further include additional physical connection ports 508a-d, which may include additional physical network ports, data transfer ports, and the like. For example, physical connection port 508a-d may include a USB port. In this example, the USB port may be used to connect the probe agent device 502 to a client device, such that detailed logs and outputs produced by the probe agent device 502 may be accessed in real-time, or the USB port may be used to connect directly to a USB storage device (e.g., a thumb drive) such that the detailed logs and outputs are stored using the USB storage device. It will be appreciated that the physical connection ports 508a-d may include a variety of different physical ports, such as SATA ports, thunderbolt ports, HDMI ports, and so forth. Thus, the probe agent 502 may include a power supply to support the various indicators, processors, memory, physical ports, and the like, such as that provided by a power supply connection 510. However, it will be appreciated that a probe agent device as described herein may be configured to run on battery power from an integrated or otherwise coupled battery, or on power provided by one of the various physical connection ports 504a-d and 508a-d.

The probe agent device depicted in FIG. 5 may be configured as a compact, standalone physical appliance suited for discreet deployment within a variety of network environments. In some embodiments, the probe agent device may be sized and shaped for placement behind a desk, within a network equipment rack, or alongside other networking appliances in a communications closet, such that the probe agent device may be installed without occupying significant physical space. Deployment contexts may include retail environments, medical offices, industrial control network installations, residential settings, and other environments where ongoing outbound port scanning may be warranted.

The probe agent device may include multiple physical network ports configured for connecting to different network segments, switches, or VLANs simultaneously. In some embodiments, each physical network port may be associated with an independent instance of the probing agent software, such that probing operations may be performed concurrently across multiple network segments from a single deployed appliance. In such configurations, the secure backend may be configured for receiving and correlating probe results from each network port independently, such that differences in egress opportunities observable across different network segments may be identified and reported as part of a consolidated assessment of the overall network security posture of the deployment environment.

For example, a single probe agent device deployed within an organization may be connected via separate physical network ports to a guest wireless network segment, an employee workstation network segment, and a server network segment simultaneously. In such a configuration, probing operations performed concurrently across all three network segments may reveal differences in outbound firewall rule enforcement across the segments, such as a guest network segment exhibiting more permissive egress policies than the server network segment. Such observations may be reported by the secure backend to a designated network administrator, along with applicable policy recommendations specific to each observed network segment.

The probe agent device may include a wireless interface configured for communicating with a cellular network, as depicted in FIG. 5. In some embodiments, the cellular interface may be configured as a failover communication path, such that the probe agent device may maintain communication with the secure backend via the cellular network in configurations where all LAN-based egress paths are unavailable, blocked, or otherwise disrupted. In such configurations, the secure backend may be configured for detecting when probe requests from a particular probe agent device are being received via the cellular interface rather than via the LAN, and for generating a notification to a designated network administrator identifying such a condition as potentially indicative of a significant network misconfiguration or disruption.

In some embodiments, the cellular interface may be configured for transmitting probe results and receiving configuration updates from the secure backend independently of any LAN- based communication path, such that the operational continuity of the probe agent device may be maintained even in network environments where LAN-based egress is entirely restricted. For example, in an industrial control network environment where outbound internet access may be intentionally restricted across all LAN-based ports and protocols, the cellular interface may represent the primary communication path between the probe agent device and the secure backend, with LAN-based probing operations continuing to be performed and results transmitted to the secure backend via the cellular interface.

The probe agent device may include one or more illuminable indicators configured for communicating operational status information to users or administrators in proximity to the probe agent device. In some embodiments, a first illuminable indicator may be configured for displaying a status associated with ongoing probing operations, such as illuminating in a first color during active probing and transitioning to a second color upon detection of an egress vector inconsistent with applicable security policies. A second illuminable indicator may be configured for displaying a status associated with the communication path between the probe agent device and the secure backend, such as illuminating solidly when communication with the secure backend is confirmed and flashing when communication has not been recently confirmed. In configurations where the probe agent device includes a cellular failover interface, a third illuminable indicator may be configured for distinguishing between LAN-based and cellular- based communication with the secure backend.

In some embodiments, multiple probe agent devices may be deployed within different network segments or VLANs of the same organizational network, such that each probe agent device may be configured for reporting its observed network identity information - including internal IP address, gateway address, and MAC address - to the secure backend following each probing cycle. The secure backend may be configured for distributing the network identity information of each deployed probe agent device to all other deployed probe agent devices within the same organizational network, such that each probe agent device may be configured for attempting to transmit probe requests addressed directly to the internal IP addresses of other deployed probe agent devices. In such configurations, the success or failure of probe requests transmitted between probe agent devices may be indicative of whether a communication path exists between the corresponding network segments, revealing inter-segment (e.g., inter VLAN) routing or firewall policies that may not be detectable by outbound probing alone.

For example, a first probe agent device deployed within a finance department VLAN and a second probe agent device deployed within a guest network VLAN of the same organization may each report their respective internal IP addresses and gateway addresses to the secure backend. The secure backend may thereafter distribute the network identity information of each probe agent device to the other, such that the first probe agent device may be configured to attempt to transmit probe requests addressed to the internal IP address of the second probe agent device, and vice versa. Successful probe requests transmitted between the two probe agent devices may indicate that a traversable communication path exists between the finance department VLAN and the guest network VLAN, which may represent a significant security gap warranting immediate remediation.

In some embodiments, inter-device probe requests may be attempted across a range of port and protocol combinations, such that the scope of any detected inter-segment communication path may be fully characterized. The secure backend may be configured for aggregating the results of inter-device probing operations alongside outbound probing results, and for evaluating all observed communication paths against applicable network segmentation policies. In configurations where a detected inter-segment communication path is inconsistent with applicable segmentation policies, the secure backend may be configured for generating a notification identifying the specific port and protocol combinations over which inter-segment communication was observed, along with the network identities of the probe agent devices between which the communication path was detected.

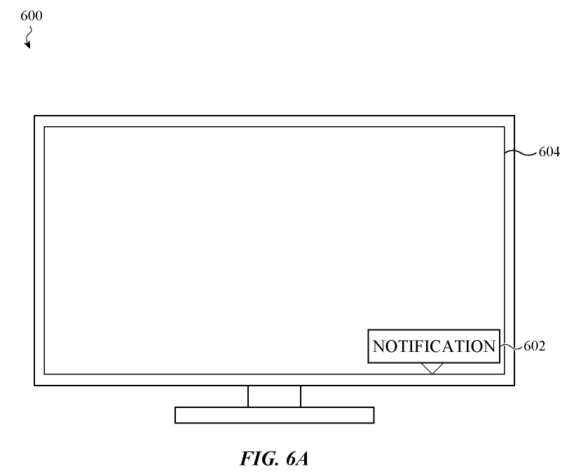

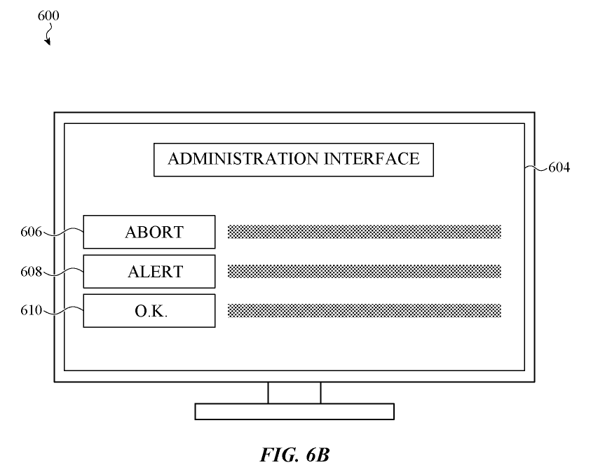

FIG. 6A-6B depict example user interface systems that may be included or otherwise associated with the systems and methods described herein. In particular, FIG. 6A depicts an example notification 602 displayed within the graphical user interface 604. As mentioned, when a probe request successfully egresses a network, it may be received at a secure backend or other like remote server as described herein. Subsequently, a response communication may be received from the secure backend or other like remote server at a device associated with the probe agent, such that a notification 602 and/or the like is displayed (e.g., as a pop-up notification).

A displayed notification 602 may include information about the probe agent, such as the port and protocol used by a particular probe request, the time the probe request was transmitted, information identifying a gateway through which the probe request egressed, and the like.

The notification 602 may be a standalone notification, or it may be associated with a particular application, web service, or the like. For instance, the notification 602 may be selectable to cause navigation to a second user interface, such as an administration or vulnerability management interface, as described in greater detail herein.

FIG. 6B depicts an example user interface that may be displayed to a user. As depicted in FIG. 6B, a user interface 604 may include graphical elements 606, 608, and 610. As depicted, these graphical elements include an abort element 606, an alert element 608, and an accept interface element 610.

For example, an interface may be configured to display additional details about detected egress vectors, successfully egressed probe requests, relevant new or known vulnerabilities, and the like. Further, an interface may be configured to display suggested and/or executable automatic operations to remedy a particular detected vulnerability. For instance, a user may select the interface element 610 to adopt or otherwise trigger any suggested operations or policies (e.g., a secure reconfiguration of port firewall rules).

As depicted in FIG. 6A, in some embodiments, a notification may be delivered to a designated client device upon the secure backend receiving and/or confirming a probe request that is inconsistent with applicable security policies. In some embodiments, the notification may be a system-level alert, an in-application notification, an email, or an SMS message, depending on the communication preferences configured for the designated recipient. The notification may be configured for presenting information identifying the port and protocol combination associated with the detected egress vector, the timestamp of the corresponding probe request, and the network identity of the probe agent device from which the probe request originated.

In some embodiments, a notification may be selectable, such that selecting the notification may cause navigation to an administration interface, such as the interface depicted in FIG. 6B. The administration interface may present a set of actionable interface elements corresponding to available responses to a detected egress vector. The abort element may be configured for causing the probe agent device to suspend probing operations or enter a quarantine mode pending administrator review. The alert element may be configured for causing a notification to be transmitted to one or more additional designated recipients, such as a security operations team. The acknowledge or accept element may be configured for acknowledging the detected egress vector and adding the corresponding port and protocol combination to an exception list, either permanently or for a defined timeout period.

In some embodiments, the administration interface may present a consolidated view of all egress vectors detected across all deployed probe agent devices within an organizational network, with options for filtering and sorting observations by network segment, port, protocol, timestamp, and policy compliance status. A network administrator may be configured for interacting with the administration interface to review historical probe results, adjust applicable security policies, and manage exception lists across all deployed probe agent devices from a single interface.

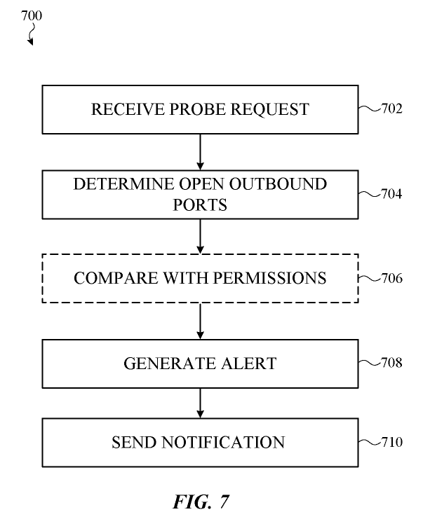

Generally, and broadly, FIGS. 7-10 depict flowcharts showing example operations of methods of using and/or operating a system such as described herein. It will be appreciated that these methods are not exhaustive and that additional or alternative operations or steps may be required or may be suitable in certain implementations.

FIG. 7 is a flowchart depicting example operations of a simplified method that may be performed by a remote server (e.g., a secure backend) in response to a successful egress probe. The method 700 includes operation 702 in which a probe request is received by a remote server, such as when a probe request addressed to the remote server successfully egresses a LAN.

The method 700 then proceeds to operation 704 in which the outbound ports (as well as the associated networking protocols) via which the probe request was able to egress are determined. For example, information about the egress probe attempt may be included within the probe request, such that the information may be extracted from the probe request by the remote server. The information may include the specific port and communication protocols (e.g., an egress vector) utilized by a received probe request.

The method 700 includes optional operation 706, wherein an egress vector associated with a probe request is compared with permissions such as a whitelist or authorization table stored at a remote server. More particularly, certain ports and protocols may be whitelisted, permitted, or otherwise approved, such that probe requests that egress a network over such permitted ports and protocols should not raise alarms or alerts (e.g., operation 708) when received. A whitelist, authorization table, or other permission record may be stored, for instance, by the backend.

In some embodiments, permissions as described herein may include blacklists and the like that identify particular high risk egress vectors. That is, a probe request that corresponds to a blacklisted egress vector or the like may trigger a heightened security response from the system (e.g., an automatic network quarantine may be triggered when a probe request is received through a blacklisted egress vector).

The method 700 also includes operation 708 in which an alert may be generated. It will be appreciated that, as mentioned, this may be an alarm, an indicator, a notification, and/or the like. For instance, operation 708 may include, as mentioned, generating one or more DNS responses to a received probe request. Responses to a probe request may be configured to cause particular messages, alerts, indicators, and alarms to be raised upon receipt (e.g., by a device within a LAN corresponding to the probe request). Further, operation 708 may include generating multiple alerts of different or like types, such as described herein. For example, an alert generated during operation 708 may include instructions that may cause certain Firewall rules to change or to otherwise cause a LAN to enter a quarantine mode.

The method 700 then proceeds to operation 710 in which a notification of the successful egress probe may be transmitted. As mentioned, a notification may include executable instructions that, upon receipt, may cause actions to be taken. For instance, executable instructions within a notification may cause illumination of indicators on a probe agent. Similarly, a notification may be configured to cause display of an alert message in a user interface of a client device. In some instances, a notification may be a conventional communication, such as an email, text, direct message, and/or the like. Further, operation 710 may include sending multiple notifications of varying or like types to multiple recipients. Recipients, as mentioned, may be authorized users associated with a LAN corresponding to a probe request, devices associated with a LAN, a probe agent device, and the like.

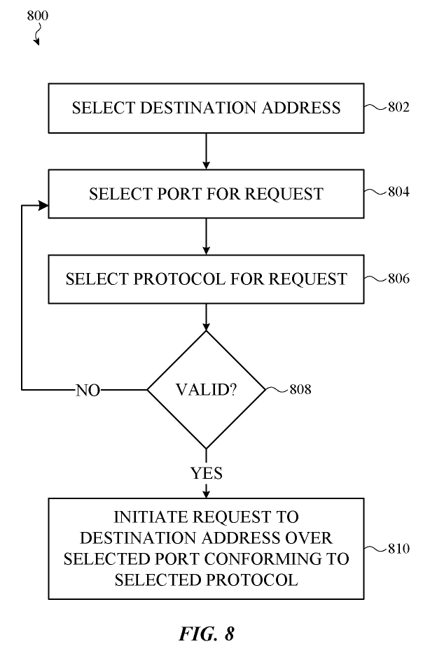

FIG. 8 is a flowchart depicting example operations of egress probing performed by the probing agent. The method 800 includes operation 802, wherein a probing agent selects a destination address, such as an address associated with a remote server as described herein.

The method 800 includes operation 804, wherein a probing agent selects a port for the probe request. As mentioned herein, a port may be selected in a variety of ways. For example, a probing agent may be configured to reference a locally stored list of ports and/or port ranges, such that ports associated with higher security risks may be probed before ports that are associated with lower security risks.

The method 800 includes operation 806, wherein a probing agent selects a protocol for the probe request. As mentioned herein, a protocol may be selected in a variety of ways. Similar to operation 804, for example, a probing agent may be configured to reference a locally stored list of protocols, such that protocols associated with higher security risks are probed before protocols that are associated with lower security risks.

In some cases, a particular port and protocol combination may be determined to be invalid prior to initiating a corresponding probe request, such as at operation 808. When a particular port and protocol combination is determined to be invalid, the method may return to operation 804. It will be appreciated that a different port need not immediately selected upon return to operation 804, as other protocols may be tested through a particular port.

Upon determining that a port and protocol combination for a request is valid, the method proceeds to operation 810, wherein the probe request is initiated. That is, operation 810 includes attempting to transmit, send, or otherwise egress a probe request conforming to a selected protocol over a selected port.

It will be appreciated that method 800 may be performed repeatedly, periodically, continuously, and the like. For example, a probing agent may be configured to repeatedly test different ports and protocols over particular intervals, and similarly, different destination addresses may be tested (e.g., such that egress opportunities may be detected even when a particular remote server is unavailable).

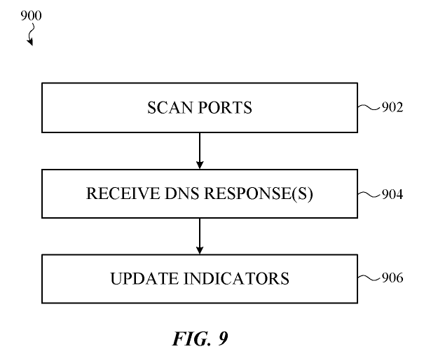

FIG. 9 is a flowchart depicting a simplified method that may be performed by a probe agent as described herein. The method 900 includes operation 902, wherein ports are scanned, such as by attempting to egress probe requests through various ports as described herein.

At operation 904, the probe agent may receive DNS responses to successfully egressed probe requests (e.g., from a remote server as described herein). As described herein, received DNS responses may be transmitted by remote servers in response to reception of probe requests.

Upon receipt of DNS responses, the method proceeds to operation 906 wherein a probe agent may be configured to correspondingly update indicators (e.g., by illuminating indicators on a probe agent device itself). As mentioned, DNS responses may include particular information that may affect whether, which, or how particular indicators may be updated. For instance, a DNS response may indicate that a particular probe request successfully egressed via a blacklisted (e.g., high risk) egress vector. Accordingly, indicators may be updated to flash red or otherwise indicate that a probe request has been received through a high-risk vector.

It will be appreciated that indicators may be updated in a variety of ways, such as green when no DNS responses are received over a particular period of time, or yellow when a probe request is received via a whitelisted egress vector, and the like. Similarly, a probe agent may include multiple indicators that may contemporaneously illuminate in different manners or otherwise reflect distinct statuses and information.

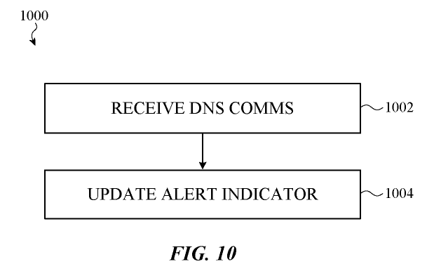

FIG. 10 is a flowchart depicting a simplified method that may be performed by a probe agent as described herein. The method 1000 includes operation 1002, wherein DNS communications are received, such as described herein. For example, a remote server may be configured to periodically transmit "all clear" DNS communications when no probe requests are received. Similarly, a remote server may be configured to transmit DNS communications in response to receiving probe requests, as described herein.

Upon receipt of DNS communications, the method 1000 proceeds to operation 1004, wherein the probe agent updates alert indicators corresponding to the DNS communications. As described herein, updating alert indicators may include updating illuminable indicators on a physical device, displaying notifications or other user interface elements on a client device, and the like.

It will be appreciated that a system as described herein can include a frontend and a backend configured to communicably couple and to cooperate in order to execute one or more operations or functions as described herein. In particular, a frontend may be a hardware device or instance of software executing by cooperation of a processor and memory of a client device. Similarly, a backend may be a remote server, secure backend, or like instance of software and/or a collection of instantiated software services (e.g., microservices) each executing by cooperation of a processor resource and memory resources allocated to each respective software service or software instance. Backend software instances can be configured to expose one or more endpoints that frontend instances can be configured to leverage to exchange structured data with the backend instances. The backend instances can be instantiated over first-party or third-party infrastructure which can include one or more physical processors and physical memory devices. The physical resources can cooperate to abstract one or more virtual processing and/or memory resources that in turn can be used to instantiate the backend instances.

The backend and the frontend can communicate over any suitable communication protocol or set of protocols to exchange structured data. The frontend can, in some cases, include a graphical user interface rendered on a display of a client device, such as a laptop computer, desktop computer, or personal phone. In some cases, the frontend may be a browser application and the graphical user interface may be rendered by a browser engine thereof in response to receiving HTML served from the backend instance or a microservice thereof.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A system for probing egress opportunities of a local area network, the system comprising:
a probe agent device configured for connecting to a network gateway of a local area network;
a processor and memory of the probe agent device configured for generating and transmitting a probe request addressed to a remote server, the probe request transmitted over a selected virtual network port using a selected networking protocol;
a remote server configured for receiving the probe request and transmitting a notification in response to receiving the probe request; and
a secure backend configured for evaluating the port and protocol combination associated with the received probe request against one or more network security policies and generating an alert upon determining that the port and protocol combination is inconsistent with the one or more network security policies.

2. The system of claim 1, wherein the probe agent device is provisioned prior to deployment with configuration information.

3. The system of claim 2, wherein the configuration information comprises information suitable to begin transmitting probe requests upon connection to the network gateway.

4. The system of claim 1, wherein the probe agent device and the remote server are configured to communicate via DNS-based command and control to exchange configuration instructions and probe results.

5. The system of claim 1, wherein the probe agent device is configured to select virtual network ports for probe requests based on a risk ranking.

6. The system of claim 5, wherein ports associated with higher security risks are probed before ports associated with lower security risks.

7. The system of claim 1, wherein the probe agent device comprises one or more illuminable indicators configured to update in response to notifications received from the remote server to indicate a detected egress vector's compliance with applicable network security policies.

8. The system of claim 1, wherein the probe agent device comprises a cellular failover interface configured to maintain communication with the remote server when all LAN-based egress paths are unavailable or blocked.

9. The system of claim 1, wherein the probe agent device comprises two or more network interfaces, each configured to independently transmit probe requests to the remote server.

10. The system of claim 1, wherein the secure backend is configured to transmit a notification to a designated network administrator upon determining that the port and protocol combination associated with a received probe request is inconsistent with a selected network security policy.

11. The system of claim 1, wherein the probe agent device is configured to periodically release and renew a DHCP lease and modify a presented MAC address.

12. A method for probing egress opportunities of a local area network, the method comprising:
selecting, by a probe agent, a virtual network port and a networking protocol;
transmitting, by the probe agent over the selected virtual network port using the selected networking protocol, a probe request addressed to a remote server;
receiving, by the remote server, the probe request;
determining, by the remote server, the virtual network port and networking protocol associated with the received probe request;
comparing, by the remote server, the virtual network port and networking protocol against one or more network security policies; and
transmitting, by the remote server, a notification to a designated recipient upon determining that the virtual network port and networking protocol are inconsistent with the one or more network security policies.

13. The method of claim 12, wherein selecting the virtual network port comprises referencing a dynamically maintained risk database associating specific port and protocol combinations.

14. The method of claim 12, further comprising encoding probe result information within a DNS query addressed to a domain assigned to the remote server.

15. The method of claim 12, further comprising transmitting the probe request to two or more distinct remote server endpoints associated with different geographic regions or infrastructure providers.

16. The method of claim 12, further comprising detecting, by the probe agent, whether outbound DNS traffic is subject to interception or redirection by the network environment.

17. The method of claim 12, further comprising adding a port and protocol combination to an exception list upon receiving an acknowledgment from a designated administrator.

18. A probe agent device for probing egress opportunities of a local area network, the probe agent device comprising:
one or more network interfaces configured to connect to a network gateway of a local area network;
a processor and memory configured to cooperate to instantiate an instance of software configured to generate and transmit probe requests addressed to a remote server over a set of virtual network port and networking protocol combinations via the one or more network interfaces;
a software-defined communication interface configured for receiving configuration instructions and transmitting probe results to the remote server; and
one or more illuminable indicators configured for updating in response to notifications received from the remote server to indicate a compliance status of one or more detected egress vectors with respect to applicable network security policies.

19. The probe agent device of claim 18, wherein the one or more illuminable indicators comprise a first indicator configured to illuminate in a first color upon detection of an egress vector inconsistent with applicable security policies, and a second indicator configured to illuminate in a second color when no policy violations have been detected.

20. The probe agent device of claim 18, wherein the processor and memory are configured to execute a statically compiled software instance having immutable program logic.
